(19) United States
(12) Patent Application Publication
(10) Pub. No.: US 2024/0038432 A1
(43) Pub. Date: Feb. 1, 2024

(54) COIL DEVICE

(71) Applicant: Mitsubishi Electric Corporation, Tokyo (JP)

(72) Inventors: Shogo Miki, Tokyo (JP); Kosuke Inoue, Tokyo (JP); Keiji Sakimoto, Tokyo (JP)

(73) Assignee: Mitsubishi Electric Corporation, Tokyo (JP)

(21) Appl. No.: 18/316,737

(22) Filed: May 12, 2023

(30) Foreign Application Priority Data
Jul. 27, 2022 (JP) 2022-119137

(51) Int. Cl. H01F 27/08; H01F 27/26

(52) U.S. Cl. CPC H01F 27/085; H01F 27/266; H01F 27/306

(57) ABSTRACT

A coil device includes a core portion whose longitudinal direction is along a winding axis of a conductive wire and a core portion other than the core portion. In a core, the core portion is provided on an attachment surface of a housing 3, the core portion is stacked on the core portion, and the combined surfaces where the core portions are combined with each other are parallel to the winding axis.

### TECHNICAL FIELD

The present disclosure relates to a coil device.

### BACKGROUND ART

In a case where a coil device such as a transformer or a reactor is used in a vehicle or the like, it is necessary to devise a measure for preventing components from falling off due to vibration. For example, the reactor device described in Patent Literature 1 includes a reactor body including a core and a coil wound around the core, and a housing that houses the reactor body, and a space between the reactor body and the housing is filled with a sealing material.

A coil body of the reactor body needs to dissipate heat generated in the coil and the core during operation to the outside. In the reactor device described in Patent Literature 1, since the space between the reactor body and the housing is filled with the sealing material, the heat generated in the coil body is transferred to the housing via the sealing material.

### CITATION LIST

### Patent Literatures

Patent Literature 1: Japanese Patent No. 6502173

### SUMMARY OF INVENTION

### Technical Problem

The conventional coil device described in Patent Literature 1 has a problem that it is necessary to fill the inside of the housing with the sealing material in order to transfer the heat generated in the coil body to the housing.

The present disclosure has been made to solve the above problem, and an object of the present disclosure is to obtain a coil device capable of transferring the heat generated in a coil body to a housing without filling the housing with a sealing material.

### Solution to Problem

A coil device according to the present disclosure includes: a coil body including a core formed by combining a plurality of core portions and at least one coil formed by winding a conductive wire around the core; and a housing including an attachment surface to which the coil body is fixed, wherein the plurality of the core portions includes a first core portion whose longitudinal direction is along a winding axis of the conductive wire and a second core portion other than the first core portion, and in the core, the first core portion is provided on the attachment surface of the housing, the second core portion is stacked on the first core portion, and combined surfaces where the core portions are combined with each other are parallel to the winding axis.

### Advantageous Effects of Invention

According to the present disclosure, the plurality of the core portions includes the first core portion whose longitudinal direction is along the winding axis of the conductive wire and the second core portion other than the first core portion, and in the core, the first core portion is provided on the attachment surface of the housing, the second core portion is stacked on the first core portion, and the combined surfaces where the core portions are combined with each other are parallel to the winding axis. The first core portion is provided on the attachment surface and the second core portion is stacked on the first core portion in such a manner that the combined surfaces are parallel to the winding axis, and the conductive wire is wound in the longitudinal direction of the first core portion along the winding axis, whereby the heat generated in the coil body is dissipated to the housing from each turn of the conductive wire. As a result, the coil device according to the present disclosure can transfer the heat generated in the coil body to the housing without filling the housing with a sealing material.

### BRIEF DESCRIPTION OF DRAWINGS

FIG. 1 is a perspective view illustrating an appearance of a coil device according to a first embodiment.

FIG. 2 is a top view illustrating the coil device according to the first embodiment.

FIG. 3 is a cross-sectional arrow view illustrating a cross section of the coil device according to the first embodiment taken along line A-A.

FIG. 4 is a cross-sectional arrow view illustrating a cross section of the coil device according to the first embodiment taken along line B-B.

FIG. 5 is a cross-sectional arrow view illustrating a cross section of the coil device according to the first embodiment taken along line C-C.

FIG. 6 is a cross-sectional arrow view illustrating a cross section of the coil device according to the first embodiment taken along line D-D.

FIG. 7 is a top view illustrating a coil fixing portion.

FIG. 8 is a top view illustrating a first modification of the coil fixing portion.

FIG. 9 is a cross-sectional arrow view illustrating a cross section of the coil device according to the first embodiment including the first modification of the coil fixing portion taken along line D-D.

FIG. 10 is a top view illustrating a second modification of the coil fixing portion.

FIG. 11 is a cross-sectional arrow view illustrating a cross section of a modification (A) of the coil device according to the first embodiment including the second modification of the coil fixing portion taken along line A-A.

FIG. 12 is a cross-sectional arrow view illustrating a cross section of a modification (B) of the coil device according to the first embodiment including the second modification of the coil fixing portion taken along line A-A.

FIG. 13 is a cross-sectional arrow view illustrating a cross section of a first modification of the coil device according to the first embodiment taken along line A-A.

FIG. 14 is a cross-sectional arrow view illustrating a cross section of a second modification of the coil device according to the first embodiment taken along line A-A.

FIG. 15 is a cross-sectional arrow view illustrating a cross section of a third modification of the coil device according to the first embodiment taken along line A-A.

FIG. 16 is a cross-sectional arrow view illustrating a cross section of a fourth modification of the coil device according to the first embodiment taken along line A-A.

FIG. 17 is a cross-sectional arrow view illustrating a cross section of a coil body included in the coil device according to the first embodiment taken along line A-A.

FIG. 18 is a cross-sectional arrow view illustrating a cross section of a modification (1A) of the coil body included in the coil device according to the first embodiment taken along line A-A.

FIG. 19 is a cross-sectional arrow view illustrating a cross section of a modification (2A) of the coil body included in the coil device according to the first embodiment taken along line A-A.

FIG. 20 is a cross-sectional arrow view illustrating a cross section of a modification (3A) of the coil body included in the coil device according to the first embodiment taken along line A-A.

FIG. 21 is a cross-sectional arrow view illustrating a cross section of a modification (4A) of the coil body included in the coil device according to the first embodiment taken along line A-A.

FIG. 22 is a cross-sectional arrow view illustrating a cross section of a fifth modification of the coil device according to the first embodiment taken along line A-A.

FIG. 23 is a cross-sectional arrow view illustrating a cross section of a sixth modification of the coil device according to the first embodiment taken along line A-A.

### DESCRIPTION OF EMBODIMENTS

### First Embodiment

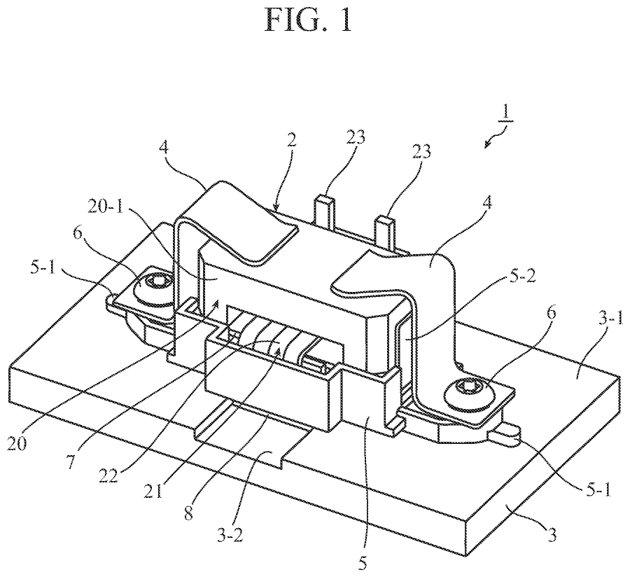

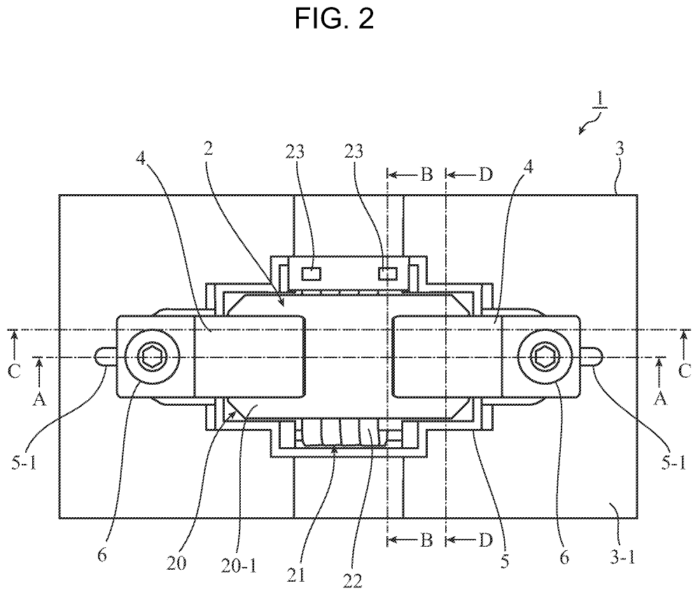

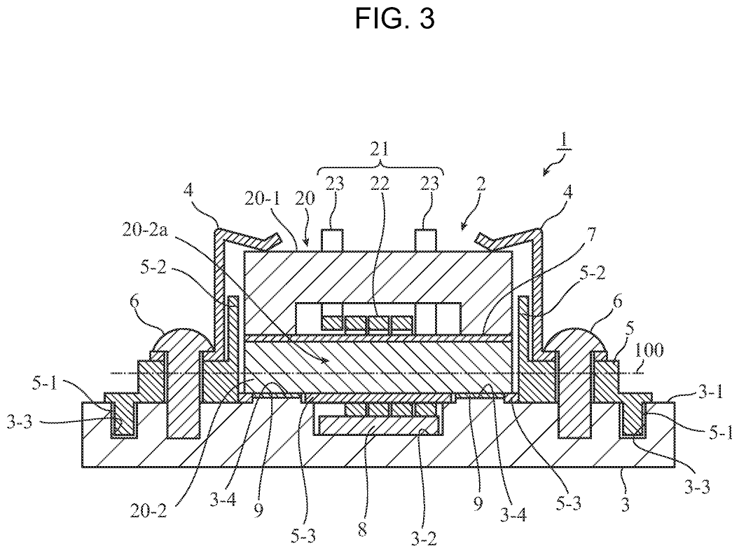

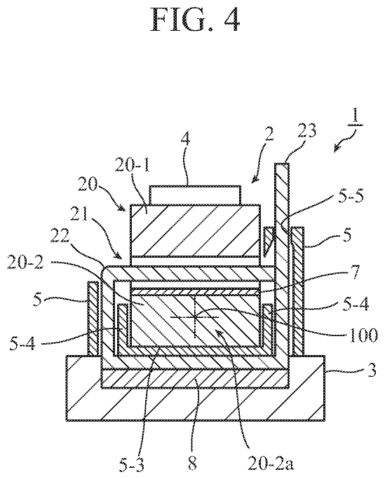

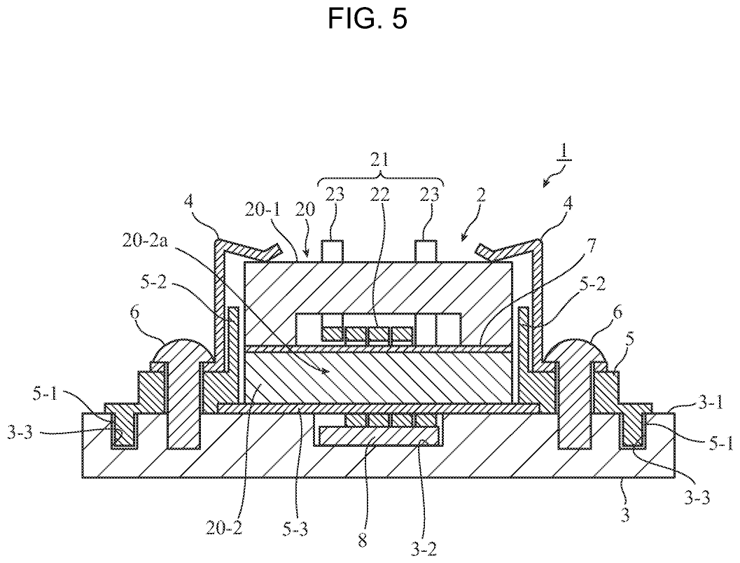

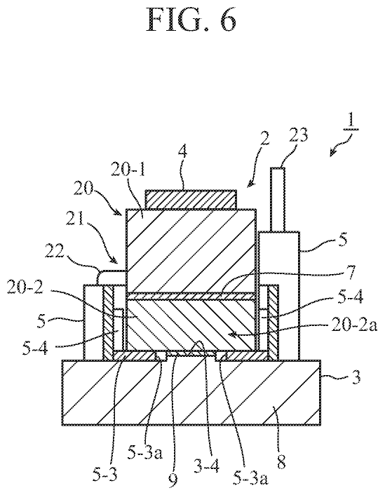

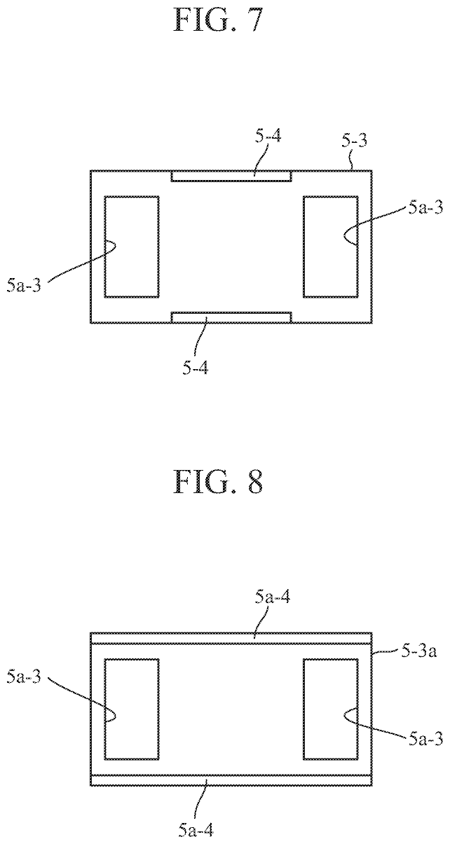

FIG. 1 is a perspective view illustrating an appearance of a coil device 1 according to a first embodiment. FIG. 2 is a top view illustrating the coil device 1. FIG. 3 is a cross-sectional arrow view illustrating a cross section of the coil device 1 taken along line A-A in FIG. 2. FIG. 4 is a cross-sectional arrow view illustrating a cross section of the coil device 1 taken along line B-B in FIG. 2. FIG. 5 is a cross-sectional arrow view illustrating a cross section of the coil device 1 taken along line C-C. FIG. 6 is a cross-sectional arrow view illustrating a cross section of the coil device 1 taken along line D-D. FIG. 7 is a top view illustrating a coil fixing portion 5-3.

In FIG. 1, the coil device 1 includes a coil body 2, a housing 3, a core hold member 4, a case 5, a fixing screw 6, a gap sheet 7, and a heat dissipation member 8. The coil body 2 includes a core 20 and a coil 21. The core 20 is formed by combining a core portion 20-1 and a core portion 20-2. The core portion 20-1 is a second core portion with a U-shape when viewed from the side.

The core portion 20-2 is a first core portion whose longitudinal direction is along a winding axis 100 of a conductive wire 22, and the core portion 20-2 has, for example, an I-shape when viewed from the side.

In the core 20, the core portion 20-2 is provided on an attachment surface 3-1 and the core portion 20-1 is stacked on the core portion 20-2 in such a manner that combined surfaces of both end portions of the U-shape in the core portion 20-1 are parallel to the winding axis 100.

Since the conductive wire 22 is wound in the longitudinal direction of the core portion 20-2 along the winding axis 100, the heat generated in the coil body 2 is dissipated to the housing 3 from each turn of the conductive wire 22.

As a result, the coil device 1 can transfer the heat generated in the coil body 2 to the housing 3 without filling the housing with a sealing material.

Note that, although the case where the core portion 20-2 has an I-shape has been described, the core portion 20-2 is only required to have a shape whose longitudinal direction is along the winding axis 100 of the conductive wire 22, and therefore may have a U-shape similarly to the core portion 20-1, for example.

The coil 21 is formed by winding the conductive wire 22 around the core portion 20-2, and both end portions of the conductive wire 22 are terminals 23. For example, as illustrated in FIG. 3, the longitudinal direction of the core portion 20-2 is along the winding axis 100, and a portion of the core portion 20-2, that is, the portion around which the conductive wire 22 is wound is a winding portion 20-2a. The conductive wire 22 is, for example, a flat wire made of copper. The flat wire is, for example, a conductive wire with a rectangular cross-sectional shape, and is wound around the core portion 20-2 by bending the long side of the cross-sectional shape. The flat wire of each turn of the coil 21 is provided on the attachment surface 3-1 of the housing 3 with the heat dissipation member 8 interposed therebetween.

In addition, the coil 21 includes an enamel-coated conductive wire 22. As a result, portions of the wound conductive wire 22 are insulated from each other, the coil 21 and the attachment surface 3-1 of the housing 3 are insulated from each other, and the core 20 and the coil 21 are also insulated from each other. Note that the conductive wire 22 is not limited to a copper wire, and may be a conductive wire of a copper alloy or an aluminum alloy.

In a case where a necessary insulation distance is kept between the portions of the wound conductive wire 22, a necessary insulation distance is kept between the coil 21 and the attachment surface 3-1 of the housing 3, and a necessary insulation distance is kept between the core 20 and the coil 21, a conductive wire 22 without enamel coating may be used.

The case 5 is attached to the attachment surface 3-1 of the housing 3. For example, as illustrated in FIG. 3, the case 5 includes a positioning projection portion 5-1, and the attachment surface 3-1 of the housing 3 includes a positioning recess portion 3-3. The positioning projection portion 5-1 is fitted into the positioning recess portion 3-3 at an attachment position of the case 5 to the housing 3. As a result, the case 5 is positioned on the attachment surface 3-1. Note that, although the case where the positioning recess portion 3-3 is provided in the attachment surface 3-1 of the housing 3 and the positioning projection portion 5-1 is provided in the case 5 has been described, the positioning projection portion may be provided on the attachment surface 3-1 and the positioning recess portion may be provided in the case 5. Also in this case, the case 5 can be positioned on the attachment surface 3-1 in the same manner as described above.

Furthermore, the attachment surface 3-1 includes a screw hole, the case 5 includes a through-hole through which the fixing screw 6 passes, and one end portion of the core hold member 4 includes a through-hole. The core hold member 4 is screwed together with the case 5 to the attachment surface 3-1 by the fixing screw 6. At this time, the other end portion of the core hold member 4 presses the core 20 toward the attachment surface 3-1, whereby the core 20 of the coil body 2 is fixed to the attachment surface 3-1.

The housing 3 is manufactured by, for example, die-casting of an aluminum alloy. Note that the housing 3 is only required to have a heat dissipation ability, and therefore aluminum, a magnesium alloy, or the like may be used as the material.

The attachment surface 3-1 of the housing 3 includes a recess portion 3-2 and a projection portion 3-4 with a shape along the outer shape of the core portion 20-2 including the coil 21. When the coil body 2 is provided on the attachment surface 3-1, the portion of the coil 21 near the housing 3 is provided to face the bottom surface of the recess portion 3-2 with the heat dissipation member 8 interposed therebetween. As illustrated in FIG. 3, the projection portion 3-4 projects from the attachment surface 3-1 and has an upper surface parallel to the core portion 20-2 which the projection portion 3-4 faces. The core portion 20-2 is provided on the upper surface of the projection portion 3-4 with a heat dissipation member 9 interposed therebetween. Since the coil 21 is thermally connected to the housing 3 by the heat dissipation member 8 and the core portion 20-2 is thermally connected to the housing 3 by the heat dissipation member 9, the heat generated in the coil body 2 is efficiently transferred to the housing 3 from each turn of the conductive wire 22.

The core hold member 4 is a member that presses the core 20 whose portion including the coil 21 faces the attachment surface 3-1 toward the attachment surface 3-1. For example, as illustrated in FIG. 3, the core hold member 4 is a member in which a sheet metal member of stainless steel or the like is bent in a Z-shape when viewed from the side, and one end portion thereof is fixed to the attachment surface 3-1 and the other end portion thereof presses the core portion 20-1 toward the attachment surface 3-1.

In addition, the core hold member 4 may be an elastic member that elastically presses the core 20 toward the attachment surface 3-1. By elastically pressing the core 20 toward the attachment surface 3-1, the heat generated in the core 20 and the coil 21 can be efficiently transferred to the housing 3 functioning as a cooler.

Note that, as illustrated in FIGS. 1 to 3, the core hold member 4 is fixed to the attachment surface 3-1 together with the case 5. For example, the position where the one end portion of the core hold member 4 is fixed to the attachment surface 3-1 is the same as the position where the case 5 is fixed to the housing 3. As a result, the component (the fixing screw 6) for fixing the core hold member 4 to the attachment surface 3-1 can be made common to the component for fixing the case 5 to the housing 3, and thereby the number of components for fixing can be reduced.

Note that, although the configuration in which the position where the one end portion of the core hold member 4 is fixed to the attachment surface 3-1 is the same as the position where the case 5 is fixed to the housing 3 has been described, they may be fixed at different positions. For example, the screwing portion for fixing the core hold member 4 to the housing 3 may be at a place different from the screwing portion for fixing the case 5 to the housing 3.

The case 5 is a case member having a wall surface portion 5-2 surrounding the coil body 2 provided on the attachment surface 3-1 of the housing 3. For example, the case 5 is formed by molding a polyphenylene sulfide resin. The case 5 includes the wall surface portion 5-2 and the coil fixing portion 5-3 in addition to the positioning projection portion 5-1. As illustrated in FIG. 4, the wall surface portion 5-2 includes a hole portion 5-5, and the coil fixing portion 5-3 has a positioning wall portion 5-4. Using the coil fixing portion 5-3 and the positioning wall portion 5-4 formed of an insulating material such as resin, the coil fixing portion 5-3 and the positioning wall portion 5-4 can insulate the coil 21 from the core portion 20-2.

In the case 5 to which the core 20 is attached, the wall surface portion 5-2 is a wall surface portion provided along a direction in which the core portion 20-1 is stacked on the core portion 20-2. The wall surface portion 5-2 restricts the movement of the core 20 in a direction perpendicular to the stacking direction of the core portion 20-1 and the core portion 20-2.

The coil fixing portion 5-3 is a member with a shape along the outer shape of the winding portion 20-2a. As illustrated in FIGS. 4 and 5, the coil 21 is formed by winding the conductive wire 22 around the winding portion 20-2a with the coil fixing portion 5-3 interposed therebetween. In addition, as illustrated in FIGS. 6 and 7, the coil fixing portion 5-3 is a member separate from the case 5. As illustrated in FIG. 7, the coil fixing portion 5-3 includes hole portions 5a-3 on both sides of the coil fixing portion 5-3. As illustrated in FIG. 6, the projection portion 3-4 provided on the attachment surface 3-1 of the housing 3 passes through the hole portion 5a-3. As a result, the core portion 20-2 is pressed by the core hold member 4 toward the attachment surface 3-1 of the housing 3 with the core portion 20-1 and the heat dissipation member 9 interposed therebetween.

The coil 21 is formed by winding the conductive wire 22 around the coil fixing portion 5-3 on which the gap sheet 7 and the core portion 20-2 are provided. The core portion 20-2 having the coil 21 formed thereon is housed in the case 5. Since the deviation of the core portion 20-2 is suppressed by the coil fixing portion 5-3 when the coil 21 is formed, the conductive wire 22 can be accurately wound around the winding portion 20-2a.

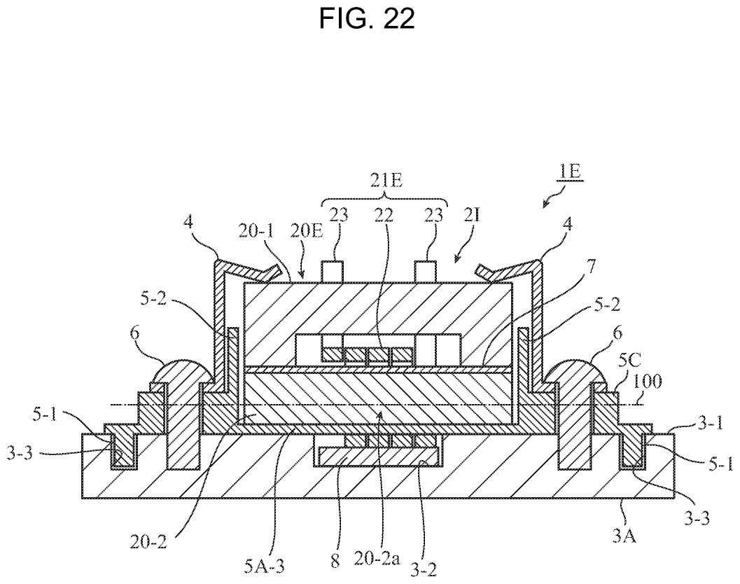

Note that, although the coil fixing portion 5-3 separate from the case 5 has been described, the coil fixing portion may be integrated with the case 5 as described later with reference to FIG. 22, for example.

In addition, the coil body 2 is fixed to the attachment surface 3-1 together with the case 5 in a state where the core 20 is attached to the case 5. In this manner, the coil body 2 can be firmly fixed to the attachment surface 3-1 by the core hold member 4 and the case 5.

Furthermore, as illustrated in FIGS. 4 and 7, the coil fixing portion 5-3 includes the positioning wall portion 5-4. The positioning wall portion 5-4 restricts the movement of the core portion 20-2 in a direction perpendicular to the stacking direction of the core portion 20-1 and the core portion 20-2 on the attachment surface 3-1. Since the positioning wall portion 5-4 restricts the movement of the core portion 20-2, the conductive wire 22 can be accurately wound around the core portion 20-2.

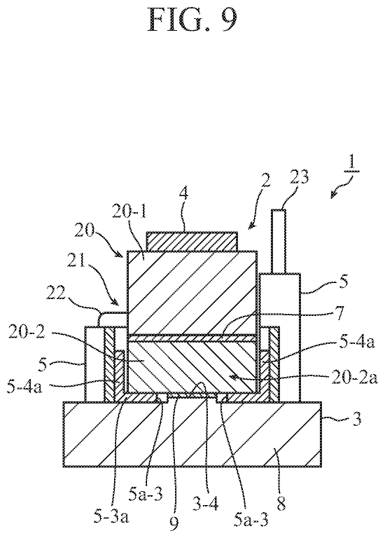

A modification of the coil fixing portion 5-3 will be described. FIG. 8 is a top view illustrating a coil fixing portion 5-3a that is a modification of the coil fixing portion 5-3. FIG. 9 is a cross-sectional arrow view illustrating a cross section of the coil device 1 including the coil fixing portion 5-3a in FIG. 8 taken along line D-D. Although the coil fixing portion 5-3 illustrated in FIG. 7 includes the positioning wall portion 5-4 only in the portion corresponding to the winding portion 20-2a of the core portion 20-2, the coil fixing portion 5-3a includes a positioning wall portion 5a-4 with a shape obtained by extending the positioning wall portion 5-4 to both end portions of the coil fixing portion 5-3 as illustrated in FIG. 8. Furthermore, the portion of the coil fixing portion 5-3a in which the winding portion 20-2a of the core portion 20-2 is provided has a shape along the outer shape of the winding portion 20-2a.

The coil 21 included in the coil device 1 illustrated in FIG. 9 is formed by winding the conductive wire 22 around the winding portion 20-2a with the coil fixing portion 5-3a interposed therebetween. When the conductive wire 22 is wound around the winding portion 20-2a, the positioning wall portion 5a-4 restricts the movement of the core portion 20-2 in the direction perpendicular to the stacking direction of the core portion 20-1 and the core portion 20-2 on the attachment surface 3-1. As a result, the conductive wire 22 can be accurately wound around the core portion 20-2.

As illustrated in FIGS. 2 and 4, the hole portion 5-5 is a hole portion through which the terminal 23 of the coil 21 passes. By passing the terminal 23 through the hole portion 5-5, the position of the terminal 23 can be accurately determined.

For example, an iron alloy screw is used as the fixing screw 6. Here, the fixing screw 6 may be made of iron, an aluminum alloy, or a copper alloy. Note that, in the coil device 1, the means for fixing the core hold member 4 and the case 5 to the attachment surface 3-1 is not limited to the fixing screw 6. As long as the core hold member 4 and the case 5 can be fixed to the attachment surface 3-1, a spring mechanism made of stainless steel, iron, an aluminum alloy, or a copper alloy may be used.

The gap sheet 7 is a sheet member with a thickness depending on the distance between the core portion 20-1 and the core portion 20-2 combined on the attachment surface 3-1. The core hold member 4 presses the core 20 with the gap sheet 7 interposed between the core portion 20-1 and the core portion 20-2 toward the attachment surface 3-1. For example, the gap sheet 7 is made of a non-magnetic material.

In a case where coil characteristics such as an inductance value or a DC superposition characteristic are changed with the distance between the core portion 20-1 and the core portion 20-2, the core portion 20-1 and the core portion 20-2 are combined with the gap sheet 7 interposed therebetween like the coil device 1. As described above, by changing the dimension of the coil body 2 in the direction of stacking the core portion 20-1 on the core portion 20-2, the coil characteristics of the coil device 1 can be changed. That is, it is not necessary to increase the area of the attachment surface 3-1 of the housing 3 in order to change the coil characteristics, and thus the downsizing of the coil device 1 can be expected.

Note that the gap sheet 7 may be made of a magnetic material with characteristics different from those of the core portion 20-1 and the core portion 20-2. Furthermore, the gap sheet 7 may have a heat dissipation ability to transfer the heat in the core portion 20-1 to the core portion 20-2.

In the coil device 1, as illustrated in FIGS. 1, 3, and 4, the heat dissipation member 8 is provided between the coil 21 and the attachment surface 3-1 (the bottom surface of the recess portion 3-2) of the housing 3. The heat dissipation member 8 is a first heat-dissipation member provided between the attachment surface 3-1 and the coil 21 in a portion of the core 20, the portion of the core 20 including the coil 21 and facing the attachment surface 3-1. The core 20 is pressed toward the attachment surface 3-1 by the core hold member 4. The portion of the coil 21 near the housing 3 is provided to face the bottom surface of the recess portion 3-2 with the heat dissipation member 8 interposed therebetween.

In the recess portion 3-2, the coil 21 is pressed against the heat dissipation member 8, and the coil 21 is fixed by a reaction force from the heat dissipation member 8. That is, the coil 21 is pushed by the reaction force from the heat dissipation member 8, the coil fixing portion 5-3 is pushed by the pushed coil 21, and the case 5 is pushed by the pushed coil fixing portion 5-3. Since the case 5 is fixed to the housing 3 by the fixing screw 6, the coil 21 is finally fixed by the reaction force from the heat dissipation member 8.

Note that, without the coil fixing portion 5-3, there is a possibility that the core portion 20-2 is damaged by being pushed by the coil 21 having received the reaction force from the heat dissipation member 8. Therefore, by providing the coil fixing portion 5-3, the coil 21 can be fixed without damaging the core portion 20-2.

The heat generated in the core 20 and the coil 21 is efficiently transferred to the attachment surface 3-1 via the heat dissipation member 8 from each turn of the conductive wire 22.

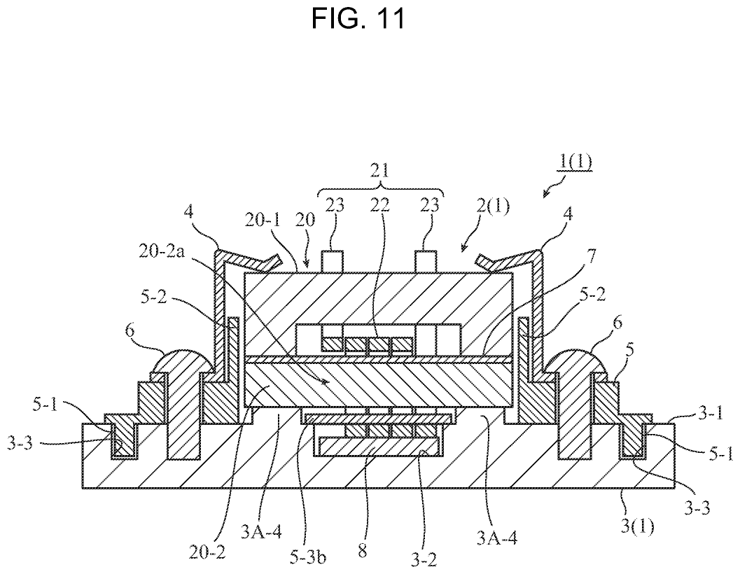

The heat dissipation member 9 is a second heat-dissipation member provided between the attachment surface 3-1 (the upper surface of the projection portion 3-4) and a portion other than the coil 21 in the portion of the core 20, the portion of the core 20 including the coil 21 and facing the attachment surface 3-1. The core hold member 4 presses the core 20 toward the attachment surface 3-1. At this time, the core portion 20-2 is fixed on the upper surface of the projection portion 3-4 with the heat dissipation member 9 interposed therebetween. The heat dissipation member 9 can efficiently transfer the heat generated in the core 20 and the coil 21 to the attachment surface 3-1. In a case where the temperature of the core 20 becomes a usable temperature without the heat dissipation member 9 interposed, the heat dissipation member 9 does not need to be provided. In this case, as will be described later with reference to FIG. 11, the core portion 20-2 directly contacts the upper surface of the projection portion 3-4 of the attachment surface 3-1 and is pressed.

The heat dissipation member 8 and the heat dissipation member 9 are heat dissipation sheets made of, for example, silicone. In addition, the heat dissipation member 8 is a sheet slightly thicker than the distance between the coil 21 and the attachment surface 3-1 of the housing 3 (the bottom surface of the recess portion 3-2). Similarly, the heat dissipation member 9 is a sheet slightly thicker than the distance between the portion other than the coil 21 and the attachment surface 3-1 of the housing 3 (the upper surface of the projection portion 3-4). The core portion 20-2 is provided on the projection portion 3-4 with the heat dissipation member 9 interposed therebetween.

Note that, although the case where the heat dissipation member 8 and the heat dissipation member 9 are silicone heat dissipation sheets has been described, these are not limited thereto. For example, the heat dissipation member 8 and the heat dissipation member 9 may be grease, curable grease, or an adhesive material. In addition, the heat dissipation member 8 and the heat dissipation member 9 may contain a filler or the like to improve the heat dissipation ability and an insulating property.

In addition, the attachment surface 3-1 of the housing 3 may be a flat surface without providing the recess portion 3-2 and the projection portion 3-4. In this case, for example, a flat surface is formed on a portion facing the attachment surface 3-1 in the outer shape of the core portion 20-2. When the core 20 is pressed toward the attachment surface 3-1 by the core hold member 4, the core portion 20-2 can be brought into close contact with the attachment surface 3-1, and thus the heat generated in the core 20 and the coil 21 can be efficiently transferred to the housing 3.

Components of a power converter including the coil device 1 may be mounted on the attachment surface 3-1 of the housing 3, and a lid-like member that covers and houses the components of the power converter including the coil device 1 on the attachment surface 3-1 may be provided. Furthermore, a cooling structure in which a refrigerant flows may be provided on the opposite surface to the attachment surface 3-1 of the housing 3. As a result, the heat generated in the core 20 and the coil 21 can be efficiently cooled.

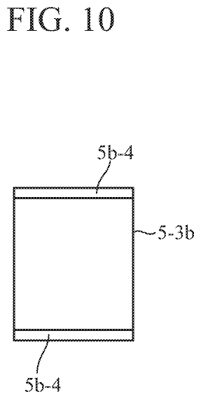

FIG. 10 is a top view illustrating a coil fixing portion 5-3b that is a second modification of the coil fixing portion 5-3. As illustrated in FIG. 10, the coil fixing portion 5-3b is formed of a member of only the portion facing the coil 21, and has a shape along the outer shape of the coil 21. The coil 21 is formed by winding the conductive wire 22 around the coil fixing portion 5-3b on which the core portion 20-2 is provided. The coil fixing portion 5-3b is provided between the projection portion 3-4 and the projection portion 3-4 adjacent to each other on the attachment surface 3-1 of the housing 3.

FIG. 11 is a cross-sectional arrow view illustrating a cross section of a coil device 1(1), which is a modification (A) of the coil device 1, taken along line A-A. The coil device 1(1) includes the coil fixing portion 5-3b. As illustrated in FIG. 11, the coil device 1(1) includes a coil body 2(1), a housing 3(1), the core hold member 4, the case 5, the fixing screw 6, the gap sheet 7, and the heat dissipation member 8. The coil body 2(1) includes the core 20 and the coil 21. The core 20 is formed by combining the core portion 20-1 and the core portion 20-2.

The attachment surface 3-1 of the housing 3(1) includes the recess portion 3-2 and a projection portion 3A-4 with a shape along the outer shape of the core portion 20-2 including the coil 21. When the coil body 2(1) is provided on the attachment surface 3-1, the coil 21 is provided to face the bottom surface of the recess portion 3-2. As illustrated in FIG. 11, the projection portion 3A-4 projects from the attachment surface 3-1 and has an upper surface parallel to the core portion 20-2 which the projection portion 3A-4 faces. The coil device 1(1) does not include the heat dissipation member 9, and the core portion 20-2 is provided in direct contact with the upper surface of the projection portion 3A-4.

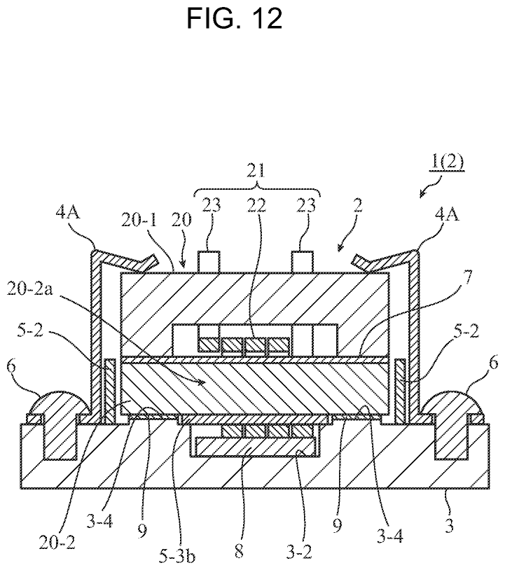

FIG. 12 is a cross-sectional arrow view illustrating a cross section of a coil device 1(2), which is a modification (B) of the coil device 1, taken along line A-A. The coil device 1(2) includes the coil fixing portion 5-3b. As illustrated in FIG. 12, the coil device 1(2) includes the coil body 2, the housing 3, a core hold member 4A, the case 5, the fixing screw 6, the gap sheet 7, and the heat dissipation member 8. The coil body 2 includes the core 20 and the coil 21. The core 20 is formed by combining the core portion 20-1 and the core portion 20-2.

As illustrated in FIG. 12, the core hold member 4A is screwed to the attachment surface 3-1 of the housing 3 using the fixing screw 6. In the cross section illustrated in FIG. 12, as to the case 5, only the wall surface portion 5-2 can be seen. The core hold member 4A presses the core 20 toward the housing 3, and the coil 21 is pressed against the heat dissipation member 8 by the pressed core 20. In a case where the coil fixing portion 5-3b is integrally formed with the case 5, the coil fixing portion 5-3b and the core portion receive the reaction force from the heat dissipation member 8 via the coil 21, whereby the case 5 is fixed.

In addition, the case 5 may be screwed to the attachment surface 3-1 at a position different from the core hold member 4A. Since the core hold member 4A is directly fixed on the attachment surface 3-1, the coil device 1(2) can be reduced in dimension in the direction projecting from the attachment surface 3-1.

Next, modifications of the coil device 1 will be described.

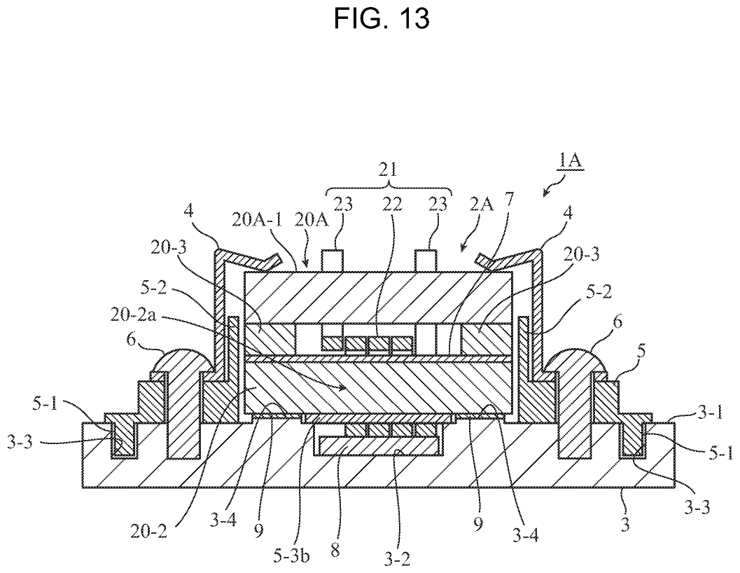

FIG. 13 is a cross-sectional arrow view illustrating a cross section of a coil device 1A, which is a first modification of the coil device 1, taken along line A-A in FIG. 2. As illustrated in FIG. 13, a coil body 2A included in the coil device 1A includes a core 20A divided into four blocks of a core portion 20A-1, the core portion 20-2, and two core portions 20-3.

The core portion 20A-1 is an I-shaped core portion similarly to the core portion 20-2. The core portion 20-3 is a rectangular parallelepiped whose longitudinal direction is shorter than those of the core portion 20A-1 and the core portion 20-2. As described above, the plurality of core portions constituting the core 20A has a simple shape such as a rectangular parallelepiped or a cube. Since each of the plurality of core portions constituting the core 20A has a simple shape, the core portions can be shared with coil devices with different specifications.

The core portion 20A-1, the core portion 20-2, and the two core portions 20-3 are combined on the attachment surface 3-1 of the housing 3 as illustrated in FIG. 13. Similarly to the coil device 1, the coil 21 is formed by winding the conductive wire 22 around the winding portion 20-2a of the core portion 20-2. In the coil body 2A, the core is pressed toward the attachment surface 3-1 by the core hold member 4. The portion of the coil 21 near the housing 3 is provided to face the bottom surface of the recess portion 3-2 with the heat dissipation member 8 interposed therebetween.

In the recess portion 3-2, the coil 21 is pressed against the heat dissipation member 8, and the coil 21 is fixed by a reaction force from the heat dissipation member 8. That is, the coil 21 is pushed by the reaction force from the heat dissipation member 8, the coil fixing portion 5-3b is pushed by the pushed coil 21, and the case 5 is pushed by the pushed coil fixing portion 5-3b. Since the case 5 is fixed to the housing 3 by the fixing screw 6, the coil 21 is finally fixed by the reaction force from the heat dissipation member 8.

Note that, in a case where the coil fixing portion 5-3b is not provided, there is a possibility that the core portion is damaged by being pushed by the coil 21 having received the reaction force from the heat dissipation member 8.

Therefore, by providing the coil fixing portion 5-3b, the coil 21 can be fixed without damaging the core portion 20-2.

As a result, similarly to the coil device 1, the coil device 1A can transfer the heat generated in the coil body 2A to the housing 3 without filling the housing 3 with a sealing material.

Note that although the coil device 1A including the core 20A divided into four core portions has been described, the number of divided portions may be three or be equal to or more than five as long as the core portions can be combined in an annular shape.

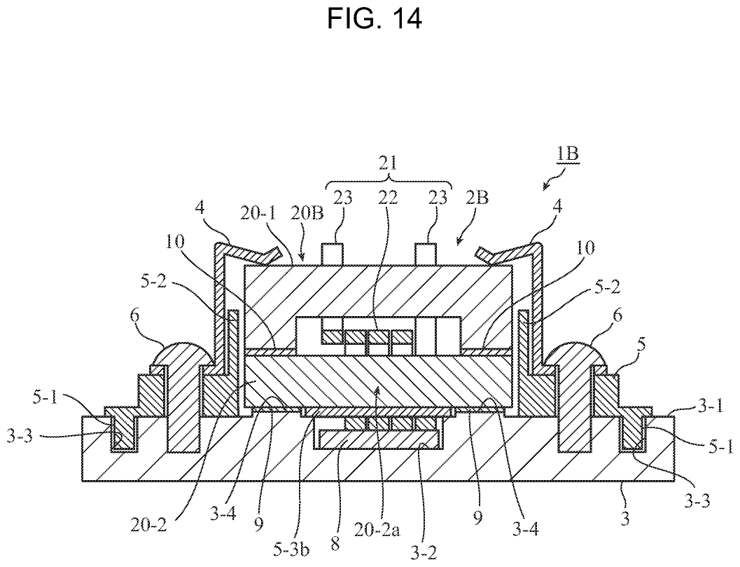

FIG. 14 is a cross-sectional arrow view illustrating a cross section of a coil device 1B, which is a second modification of the coil device 1, taken along line A-A in FIG. 2. As illustrated in FIG. 14, a coil body 2B included in the coil device 1B includes a heat dissipation member 10 instead of the gap sheet 7. The heat dissipation member 10 is a third heat-dissipation member provided between the combined surfaces where the core portion 20-1 and the core portion 20-2 are combined with each other.

The heat dissipation member 10 is a heat dissipation sheet made of, for example, silicone. In addition, the heat dissipation member 10 may be grease, curable grease, or an adhesive material. Furthermore, the heat dissipation member 10 may contain a filler or the like to improve the heat dissipation ability and the insulating property.

For example, in a case where the size of the core portion 20-1 is increased in order to improve the heat dissipation ability, the heat dissipation member 10 is provided between the combined surfaces where the core portion 20-1 and the core portion 20-2 are combined with each other. As a result, the heat from the core portion 20-1 is transferred to the housing 3 via the heat dissipation member 10 and the core portion 20-2, and thus, it is possible to minimize an increase in the size of the core portion 20-1 necessary for improving the heat dissipation ability of the core portion 20-1.

Note that, although the configuration in which the gap sheet 7 or the heat dissipation member 10 is provided between the core portion 20-1 and the core portion 20-2 has been described, the core portion 20-1 and the core portion 20-2 may be directly connected without providing the gap sheet 7 or the heat dissipation member 10 depending on the characteristics to be provided in the coil device.

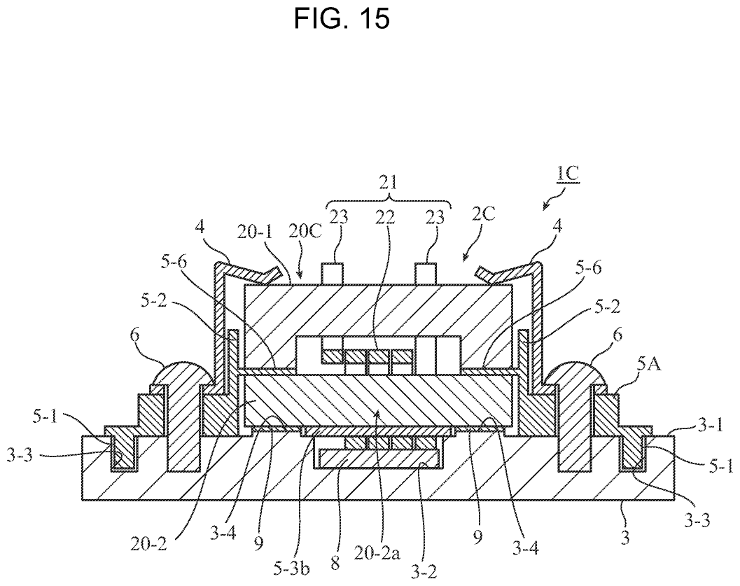

FIG. 15 is a cross-sectional arrow view illustrating a cross section of a coil device 1C, which is a third modification of the coil device 1, taken along line A-A in FIG. 2. The coil device 1C includes a coil body 2C, the housing 3, the core hold member 4, and a case 5A. The coil body 2C includes a core 20C and the coil 21. In the coil body 2C, instead of the gap sheet 7, a plate-like portion 5-6 provided in the case 5A is provided between the core portion and the core portion 20-2.

The plate-like portion 5-6 is a plate-like portion that is provided in the case 5A and has a thickness depending on the distance between the core portion 20-1 and the core portion 20-2 in the core portion 20-1 and the core portion 20-2 combined on the attachment surface 3-1. For example, the plate-like portion 5-6 is a plate-like member extending from the wall surface portion of the case 5A to the core 20C, and as illustrated in FIG. 15, has a dimension that fills the entire gap between the core portion 20-1 and the core portion 20-2.

For example, in the coil device 1C, the plate-like portion 5-6 is provided between the combined surfaces where the core portion 20-1 and the core portion 20-2 are combined with each other. Similarly to the gap sheet 7, the distance between the core portion 20-1 and the core portion 20-2 can be changed depending on the thickness of the plate-like portion 5-6, and the coil characteristics of the coil device 1C can be changed accordingly. As described above, since the plate-like portion 5-6 included in the case 5A can be provided instead of the gap sheet 7, the number of components in the coil device 1C can be reduced by the gap sheet 7.

By the core hold member 4 pressing the core portion 20-1 toward the attachment surface 3-1 of the housing 3, the core portion 20-1 is pressed against and fixed to the plate-like portion 5-6, and the core portion 20-2 is fixed to the projection portion 3-4 with the heat dissipation member 9 interposed therebetween. The portion of the coil 21 near the housing 3 is provided to face the bottom surface of the recess portion 3-2 with the heat dissipation member 8 interposed therebetween.

In the recess portion 3-2, the coil 21 is pressed against the heat dissipation member 8, and the coil 21 is fixed by a reaction force from the heat dissipation member 8. That is, the coil 21 is pushed by the reaction force from the heat dissipation member 8, the coil fixing portion 5-3b is pushed by the pushed coil 21, and the case 5A is pushed by the pushed coil fixing portion 5-3b. Since the case 5A is fixed to the housing 3 by the fixing screw 6, the coil 21 is finally fixed by the reaction force from the heat dissipation member 8.

Note that, in a case where the coil fixing portion 5-3b is not provided, there is a possibility that the core portion 20-2 is damaged by being pushed by the coil 21 having received the reaction force from the heat dissipation member 8.

Therefore, by providing the coil fixing portion 5-3b, the coil 21 can be fixed without damaging the core portion 20-2.

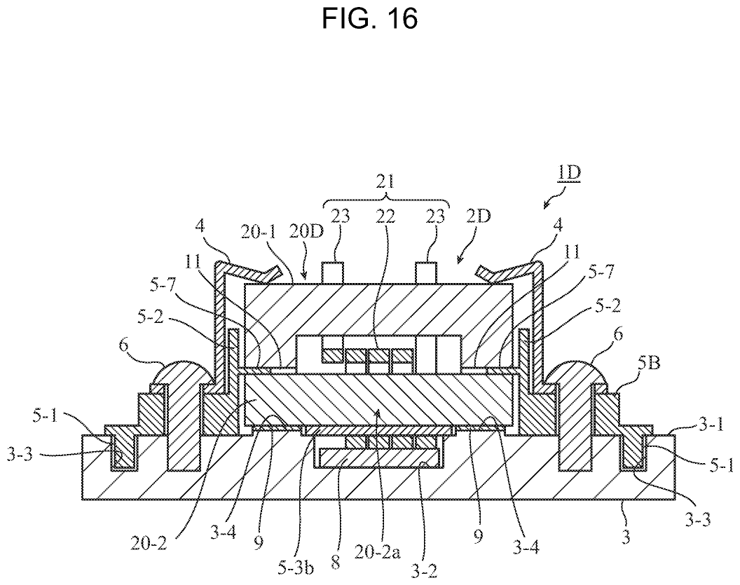

FIG. 16 is a cross-sectional arrow view illustrating a cross section of a coil device 1D, which is a fourth modification of the coil device 1, taken along line A-A in FIG. 2. The coil device 1D includes a coil body 2D, the housing 3, the core hold member 4, a case 5B, and a heat dissipation member 11. The coil body 2D includes a core 20D and the coil 21. In the coil body 2D, instead of the gap sheet 7, the heat dissipation member 11 and a plate-like portion 5-7 provided in the case 5B are provided between the core portion 20-1 and the core portion 20-2.

The plate-like portion 5-7 is a plate-like portion that is provided in the case 5B and has a thickness depending on the distance between the core portion 20-1 and the core portion 20-2 in the core portion 20-1 and the core portion 20-2 combined on the attachment surface 3-1. For example, the plate-like portion 5-7 is a plate-like member extending from the wall surface portion of the case 5B to the core 20D. Here, the dimension of the plate-like portion 5-7 in a direction parallel to the attachment surface 3-1 of the housing 3 is shorter than that of the plate-like portion 5-6, and the plate-like portion 5-7 cannot completely fill the gap between the core portion 20-1 and the core portion 20-2. The heat dissipation member 11 is provided in the portion where the plate-like portion 5-7 is not present in the gap between the core portion 20-1 and the core portion 20-2.

The heat dissipation member 11 is a third heat-dissipation member provided between the combined surfaces where the core portion 20-1 and the core portion 20-2 are combined with each other in the core portion 20-1 and the core portion 20-2 combined on the attachment surface 3-1. As illustrated in FIG. 16, the heat dissipation member 11 is provided between portions of the combined surfaces where the core portion 20-1 and the core portion 20-2 are combined with each other, no plate-like portion 5-7 being provided between the portions of the combined surfaces. Note that the heat dissipation member 11 is a heat dissipation sheet made of, for example, silicone. In addition, the heat dissipation member 11 may be grease, curable grease, or an adhesive material. The heat dissipation member 11 may contain a filler or the like to improve the heat dissipation ability and the insulating property.

For example, in a case where the size of the core portion 20-1 is increased in order to improve the heat dissipation ability, the plate-like portion 5-7 and the heat dissipation member 11 are provided between the combined surfaces where the core portion 20-1 and the core portion 20-2 are combined with each other. As a result, the heat from the core portion 20-1 is transferred to the housing 3 via the plate-like portion 5-7, the heat dissipation member 11, and the core portion 20-2, and thus, it is possible to suppress an increase in the size of the core portion 20-1 necessary for improving the heat dissipation ability of the core portion 20-1.

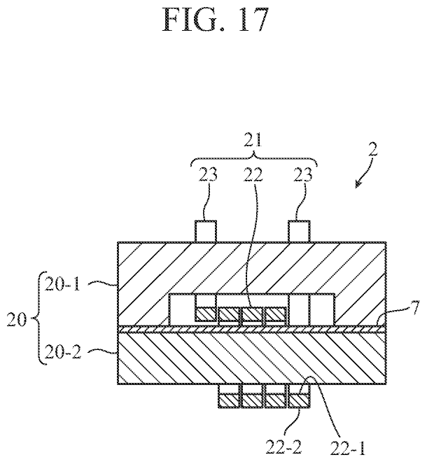

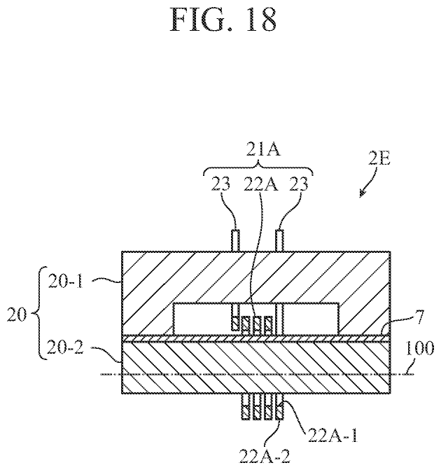

FIG. 17 is a cross-sectional arrow view illustrating a cross section of the coil body 2 included in the coil device 1 taken along line A-A in FIG. 2. As illustrated in FIG. 17, the coil 21 included in the coil body 2 is formed by winding the flat conductive wire 22 around the core portion 20-2. The conductive wire 22, which is a flat wire, has an inner surface 22-1 facing the core 20 and an outer surface 22-2 opposite to the inner surface 22-1.

Note that although the illustration of the coil fixing portion is omitted in FIG. 17, it is assumed that the coil body 2 includes the coil fixing portion. Here, in a case where the heat dissipation member 8 is curable grease or an adhesive material, the coil fixing portion does not need to be provided.

The coil 21 is a flatwise coil in which the long side of a flat wire with a rectangular cross-sectional shape is wound around the core portion 20-2. That is, the coil 21 is wound in such a manner that the outer surface 22-2 of the flat wire is parallel to the attachment surface 3-1. In the flatwise coil, the area where the conductive wire 22 of the coil 21 and the attachment surface 3-1 face each other increases, and thereby the heat generated in the coil 21 can be efficiently transferred to the housing 3 from each turn of the conductive wire 22.

FIG. 18 is a cross-sectional arrow view illustrating a cross section of a coil body 2E, which is a modification (1A) of the coil body 2, taken along line A-A in FIG. 2. As illustrated in FIG. 18, a coil 21A included in the coil body 2E is formed by winding a flat conductive wire 22A around the core portion 20-2. The conductive wire 22A, which is a flat wire, has an inner surface 22A-1 facing the core 20 and an outer surface 22A-2 opposite to the inner surface 22A-1.

Note that although the illustration of the coil fixing portion is omitted in FIG. 18, it is assumed that the coil body 2E includes the coil fixing portion. Here, in a case where the heat dissipation member 8 is curable grease or an adhesive material, the coil fixing portion does not need to be provided.

The coil 21A is an edgewise coil in which the short side of a flat wire with a rectangular cross-sectional shape is wound around the core portion 20-2. That is, the coil 21A is wound in such a manner that the outer surface 22A-2 of the flat wire is parallel to the attachment surface 3-1. Since the edgewise coil can be made smaller in dimension in the direction of the winding axis 100 than the flatwise coil, the coil device 1 can be downsized.

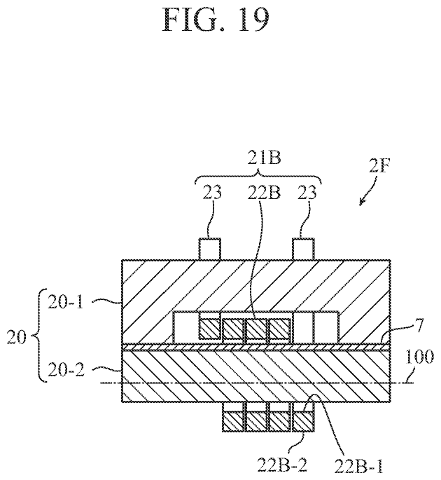

FIG. 19 is a cross-sectional arrow view illustrating a cross section of a coil body 2F, which is a modification (2A) of the coil body 2, taken along line A-A in FIG. 2. As illustrated in FIG. 19, a coil 21B included in the coil body 2F is formed by winding a flat conductive wire 22B around the core portion 20-2. In the coil 21B, a flat wire with a square cross-sectional shape is wound around the core portion 20-2. The conductive wire 22B has an inner surface 22B-1 facing the core 20 and an outer surface 22B-2 opposite to the inner surface 22B-1.

Note that although the illustration of the coil fixing portion is omitted in FIG. 19, it is assumed that the coil body 2F includes the coil fixing portion. Here, in a case where the heat dissipation member 8 is curable grease or an adhesive material, the coil fixing portion does not need to be provided.

The coil 21B is wound in such a manner that the outer surface 22B-2 of the conductive wire 22B is parallel to the attachment surface 3-1. By using the flat wire with a square cross-sectional shape, the coil 21B can be made smaller in dimension in the direction of the winding axis 100 than the coil 21 of the flatwise coil, and the area where the conductive wire 22B of the coil 21B and the attachment surface 3-1 face each other can be made enough, whereby the heat generated in the coil 21B can be efficiently transferred to the housing 3.

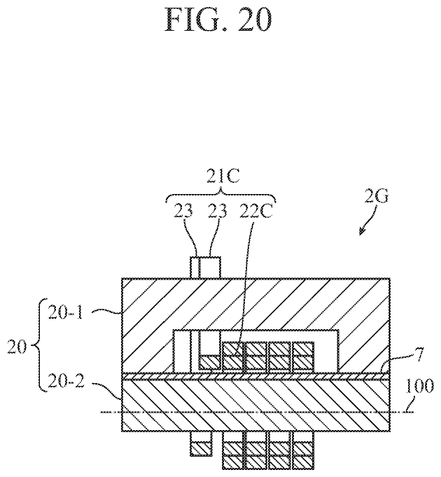

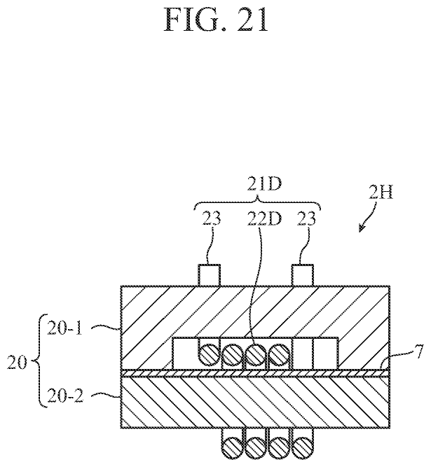

FIG. 20 is a cross-sectional arrow view illustrating a cross section of a coil body 2G, which is a modification (3A) of the coil body 2, taken along line A-A in FIG. 2. As illustrated in FIG. 20, a coil 21C included in the coil body 2G is formed by winding a flat conductive wire 22C in two layers around the core portion 20-2.

Note that although the illustration of the coil fixing portion is omitted in FIG. 20, it is assumed that the coil body 2G includes the coil fixing portion. Here, in a case where the heat dissipation member 8 is curable grease or an adhesive material, the coil fixing portion does not need to be provided.

In the coil 21C, the coil in the first layer and the coil in the second layer can be used for different functions. That is, the coil 21C can be used as two coils. Furthermore, in a case where the number of windings of one coil is large, since the size is increased by winding the coil in a single layer, the size is reduced by winding the coil in two layers. That is, one coil may be formed into two layers for downsizing.

For example, the conductive wire 22C is an enamel-coated conductive wire, thus portions of the conductive wire 22C in each layer and in different layers wound in two layers are insulated from each other, the coil 21C and the attachment surface 3-1 of the housing 3 are insulated from each other, and the core 20 and the coil 21C are also insulated from each other. In addition, the conductive wire 22C is not limited to a copper wire, and may be a conductive wire of a copper alloy or an aluminum alloy.

The coil 21C can be made shorter in dimension in the direction of the winding axis 100 than a structure in which two coils are formed along the winding axis 100. As a result, the coil device can be downsized.

The coil 21C is not limited to two layers, and may be formed by winding the conductive wire 22 in three or more layers.

FIG. 21 is a cross-sectional arrow view illustrating a cross section of a coil body 2H, which is a modification (4A) of the coil body 2, taken along line A-A in FIG. 2. As illustrated in FIG. 21, a coil 21D included in the coil body 2H is formed by winding a round conductive wire 22D around the core portion 20-2. Since the round wire is more inexpensive than the flat wire, the cost of the coil 21D can be reduced.

Note that although the illustration of the coil fixing portion is omitted in FIG. 21, it is assumed that the coil body 2H includes the coil fixing portion. Here, in a case where the heat dissipation member 8 is curable grease or an adhesive material, the coil fixing portion does not need to be provided.

FIG. 22 is a cross-sectional arrow view illustrating a cross section of a coil device 1E, which is a fifth modification of the coil device 1, taken along line A-A in FIG. 2. As illustrated in FIG. 22, the coil device 1E includes a coil body 2I, a housing 3A, the core hold member 4, a case 5C, and the gap sheet 7. The coil body 2I includes a core 20E and a coil 21E. The core 20E is formed by combining the core portion 20-1 and the core portion 20-2 in an annular shape. The core portion 20-1 has a U-shape when viewed from the side, and the core portion 20-2 has an I-shape when viewed from the side.

The attachment surface 3-1 of the housing 3A includes the recess portion 3-2 along the outer shape of the coil 21E. Here, unlike the coil device 1, the attachment surface 3-1 of the housing 3A is a flat surface without the projection portion 3-4. When the coil body 2I is provided on the attachment surface 3-1, the coil 21E is provided to face the bottom surface of the recess portion 3-2.

The case 5C is a case member having the wall surface portion 5-2 surrounding the coil body 2I provided on the attachment surface 3-1 of the housing 3A. For example, the case 5C is formed by molding a polyphenylene sulfide resin. The wall surface portion 5-2 and a coil fixing portion 5A-3 are integrally formed in the case 5C in addition to the positioning projection portion 5-1.

The coil fixing portion 5A-3 is a part of the case 5C with a shape along the outer shape of the winding portion 20-2a, and as illustrated in FIG. 22, the coil fixing portion 5A-3 is continuous in the direction of the winding axis 100 in the case 5C. The coil 21E is formed by winding the flat conductive wire 22 around the winding portion 20-2a with the coil fixing portion 5A-3 interposed therebetween. That is, by forming the coil 21E, the core 20E is attached to the case 5C via the coil fixing portion 5A-3, which is a part of the case 5C. Since the deviation of the core portion 20-2 is suppressed by the coil fixing portion 5A-3, the conductive wire 22 can be accurately wound around the winding portion 20-2a.

The core portion 20-2 is provided on the attachment surface 3-1 of the housing 3A with the coil fixing portion 5A-3 interposed therebetween. The outer shape of the portion of the coil fixing portion 5A-3 near the attachment surface 3-1 other than the coil 21E is a flat surface. As illustrated in FIG. 22, the flat surface of the coil fixing portion 5A-3 is combined with a flat surface provided instead of the projection portion 3-4 on the attachment surface 3-1 of the housing 3A. As a result, the coil body 2I can be attached to the housing 3A even if the attachment surface 3-1 of the housing 3A is a simple surface without the projection portion 3-4.

Furthermore, similarly to the coil fixing portion 5-3, the coil fixing portion 5A-3 may have the positioning wall portion 5-4. The positioning wall portion 5-4 restricts the movement of the core portion 20-2 in the direction perpendicular to the stacking direction of the core portion 20-1 and the core portion 20-2 stacked on the attachment surface 3-1. Since the positioning wall portion 5-4 restricts the movement of the core portion 20-2, the conductive wire 22 can be accurately wound around the core portion 20-2.

Furthermore, as illustrated in FIG. 22, the portion of the coil fixing portion 5A-3 near the core portion 20-2 is a flat surface. In the coil 21E, the flat surface of the coil fixing portion 5A-3 is combined with the flat surface of the core portion 20-2. Furthermore, in a state where the coil fixing portion 5A-3 is in contact with the flat surface other than the recess portion 3-2 of the attachment surface 3-1, the portion of the coil 21E near the housing 3A is provided to face the bottom surface of the recess portion 3-2 with the heat dissipation member 8 interposed therebetween. In the recess portion 3-2, the coil 21E is pressed against the heat dissipation member 8, and the coil 21E is fixed by a reaction force from the heat dissipation member 8. The heat generated in the core 20E and the coil 21E is dissipated to the housing 3A via the coil fixing portion 5A-3 and the heat dissipation member 8.

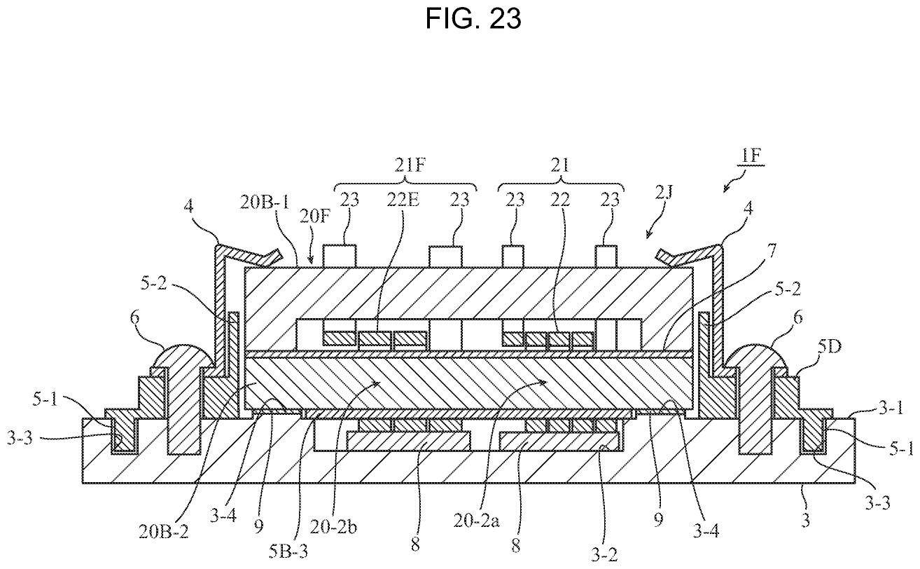

FIG. 23 is a cross-sectional arrow view illustrating a cross section of a coil device 1F, which is a sixth modification of the coil device 1, taken along line A-A in FIG. 2. As illustrated in FIG. 23, the coil device 1F includes a coil body 2J, the housing 3, the core hold member 4, a case 5D, the gap sheet 7, the heat dissipation member 8, and the heat dissipation member 9. The coil body 2J includes a core 20F, the coil 21, and a coil 21F.

The core 20F is formed by combining a core portion 20B-1 and a core portion 20B-2. The core portion 20B-2 is a first core portion whose longitudinal direction is along the winding axis, and the core portion 20B-1 is a second core portion stacked on the core portion 20B-2. The core portion 20B-2 includes the winding portion 20-2a and a winding portion 20-2b that have a common winding axis.

The coil 21 is formed by winding the flat conductive wire 22 around the winding portion 20-2a. In addition, the conductive wire 22 is, for example, a flat wire made of copper. The flat wire is, for example, a conductive wire with a rectangular cross-sectional shape, and is wound around the winding portion 20-2a by bending the long side of the cross-sectional shape.

The coil 21F is formed by winding a flat conductive wire 22E around the winding portion 20-2b. In addition, the conductive wire 22E is, for example, a flat wire made of copper, and is wider and has a larger cross-sectional area than the conductive wire 22. The conductive wire 22E, which is a flat wire, is wound around the winding portion 20-2b by bending the long side of the cross-sectional shape. Since the deviation of the core portion 20B-2 is suppressed by a coil fixing portion 5B-3, the conductive wire 22 and the conductive wire 22E can be accurately wound around the winding portion 20-2a and the winding portion 20-2b, respectively.

The case 5D is a case member having the wall surface portion 5-2 surrounding the coil body 2J provided on the attachment surface 3-1 of the housing 3. For example, the case 5D is formed by molding a polyphenylene sulfide resin. The case 5D includes the wall surface portion 5-2 and the coil fixing portion 5B-3 in addition to the positioning projection portion 5-1.

Each of the portion of the coil 21 near the housing 3 and the portion of the coil 21F near the housing 3 is provided to face the bottom surface of the recess portion 3-2 with the heat dissipation member 8 interposed therebetween. In the recess portion 3-2, the coil 21 is fixed by a reaction force from the heat dissipation member 8 against which the coil 21 is pressed. That is, the coil 21 is pushed by the reaction force from the heat dissipation member 8, the coil fixing portion 5B-3 is pushed by the pushed coil 21, and the case 5D is pushed by the pushed coil fixing portion 5B-3. Since the case 5D is fixed to the housing 3A by the fixing screw 6, the coil 21 is finally fixed by the reaction force from the heat dissipation member 8.

Similarly, the coil 21F is fixed by a reaction force from the heat dissipation member 8 against which the coil 21F is pressed. That is, the coil 21F is pushed by the reaction force from the heat dissipation member 8, the coil fixing portion 5B-3 is pushed by the pushed coil 21F, and the case 5D is pushed by the pushed coil fixing portion 5B-3. Since the case 5D is fixed to the housing 3A by the fixing screw 6, the coil 21F is finally fixed by the reaction force from the heat dissipation member 8.

Note that, in a case where the coil fixing portion 5B-3 is not provided, there is a possibility that the core portion 20B-2 is damaged by being pushed by the coil 21 and the coil 21F each having received the reaction force from the heat dissipation member 8.

Therefore, by providing the coil fixing portion 5B-3, the coil 21 and the coil 21F can be fixed without damaging the core portion 20B-2.

Furthermore, similarly to the coil fixing portion 5-3, the coil fixing portion 5B-3 may have the positioning wall portion 5-4. The positioning wall portion 5-4 restricts the movement of the core portion 20B-2 in a direction perpendicular to the stacking direction of the core portion 20B-1 and the core portion 20B-2 stacked in an annular shape on the attachment surface 3-1. Since the positioning wall portion 5-4 restricts the movement of the core portion 20B-2, each of the conductive wire 22 and the conductive wire 22E can be accurately wound around the core portion 20B-2.

The type of the conductive wire and the number of turns are different between the coil 21 and the coil 21F. For example, in a case where the coil device 1F has a function of stepping down an input voltage and outputting the resultant voltage, the coil 21 is used as a coil on a primary side, and the coil 21F is used as a coil on a secondary side. The coil 21 that includes the conductive wire 22 with a cross-sectional area smaller than that of the conductive wire 22E and has a larger number of turns than that of the coil 21F is used at a high voltage and a small current. On the other hand, the coil 21F that includes the conductive wire 22E with a large cross-sectional area and has a smaller number of turns than that of the coil 21 is used at a low voltage and a large current.

The type of the conductive wire and the number of turns in the coil 21 may be the same as those in the coil 21F. With such a configuration, it can be used for a device using a plurality of coils with the same characteristics.

Furthermore, the coil device 1F is not limited to the coil 21 and the coil 21F, and three or more coils may be formed in the core portion 20B-2. As a result, the coil device 1F can be used for various applications. For example, the coil device 1F in which the type of the conductive wire and the number of turns in the coil 21 are the same as those in the coil 21F and thus the coil 21 and the coil 21F have the same coil characteristics can be used for a plurality of devices using the same coil characteristics.

Although the case where the conductive wires constituting the coil 21 and the coil 21F are both flat wires has been described, different types of conductive wires may be used in the coil 21 and the coil 21F. For example, the coil 21 may be formed of a flat wire, and the coil 21F may be formed of a round wire. In addition, the coil body 2J may be downsized by using a round wire or an edgewise coil of a flat wire in the coil with a larger number of turns out of the coil 21 and the coil 21F.

Furthermore, a flatwise coil of a flat wire may be used in the coil with a smaller number of turns out of the coil 21 and the coil 21F, in order to increase the contact area with the heat dissipation member 8. As a result, heat dissipation of the coil body 2J included in the coil device 1F is enhanced. In addition, since the coil device 1F does not require a sealing material, it is possible to reduce the number of components necessary for introducing the sealing material while maintaining the heat dissipation ability of the coil body 2J. As a result, the coil device 1F can also be downsized.

As described above, the coil device 1 according to the first embodiment includes the coil body 2 having the core 20 formed by combining the core portions 20-1 and 20-2 and the coil 21 formed by winding the conductive wire 22 around the core 20, and the housing 3 having the attachment surface 3-1 to which the coil body 2 is fixed. The core includes the core portion 20-2 whose longitudinal direction is along the winding axis 100 of the conductive wire 22 and the core portion 20-1 other than the core portion 20-2. In the core 20, the core portion 20-2 is provided on the attachment surface 3-1 of the housing 3, the core portion 20-1 is stacked on the core portion 20-2, and the combined surfaces where the core portion 20-1 and the core portion 20-2 are combined with each other are parallel to the winding axis 100.

The core portion 20-2 is provided on the attachment surface 3-1 in such a manner that the combined surfaces where the core portion 20-1 and the core portion 20-2 are combined with each other are parallel to the winding axis 100, the core portion 20-1 is stacked on the core portion 20-2, and the conductive wire 22 is wound in the longitudinal direction of the core portion 20-2 along the winding axis 100, whereby the heat generated in the coil body 2 is dissipated to the housing from each turn of the conductive wire 22.

As a result, the coil device 1 can transfer the heat generated in the coil body 2 to the housing 3 without filling the housing with a sealing material.

In addition, it is not necessary to have a structure for filling it with the sealing material (for example, a wall portion of the housing for filling it with the sealing material) and a dedicated facility (for example, a facility for filling it with the sealing material and degassing). Therefore, the number of components can be reduced and complication of a manufacturing process can be suppressed. By reducing the number of components, the downsizing of the coil device 1 can also be expected.

Note that the effects similar to those described above can also be obtained in the coil device LA including the core 20A including the core portions 20A-1, 20-2, and 20-3. The effects similar to those described above can also be obtained in the coil device 1F including the core 20F including the coil 21 and the coil 21F.

The coil device 1 according to the first embodiment includes the heat dissipation member 8 provided between the coil 21 and the attachment surface 3-1, and the coil 21 is provided on the attachment surface 3-1 with the heat dissipation member 8 interposed therebetween. The heat dissipation member 8 can efficiently transfer the heat generated in the coil 21 to the attachment surface 3-1.

The coil device 1 according to the first embodiment includes the heat dissipation member 9 provided between the portion of the core portion 20-2 other than the coil 21 and the attachment surface 3-1. The portion of the core portion 20-2 other than the coil 21 is provided on the attachment surface 3-1 with the heat dissipation member 9 interposed therebetween. The heat dissipation member 9 can efficiently transfer the heat generated around the coil 21 to the attachment surface 3-1.

The coil device 1B according to the first embodiment includes the heat dissipation member 10 provided between the combined surfaces where the core portion 20-1 and the core portion 20-2 are combined with each other. The core portion 20-1 and the core portion 20-2 are combined on the attachment surface 3-1 with the heat dissipation member 10 interposed between the combined surfaces where the core portion 20-1 and the core portion 20-2 are combined with each other. The heat from the core portion 20-1 is easily transferred to the housing 3 via the heat dissipation member 10, and thus the heat dissipation ability of the core portion 20-1 is improved.

The coil device 1 according to the first embodiment includes the gap sheet 7 with a thickness depending on the distance between the core portion 20-1 and the core portion 20-2. The core portion 20-1 and the core portion 20-2 are combined on the attachment surface 3-1 with the gap sheet 7 interposed between the combined surfaces where the core portion 20-1 and the core portion 20-2 are combined with each other. By providing the gap sheet 7, the coil characteristics such as an inductance value or a DC superposition characteristic can be changed with the distance between the core portion 20-1 and the core portion 20-2. In addition, when the gap sheet 7 has a heat dissipation ability, the heat generated in the core portion 20-1 can be efficiently transferred to the core portion 20-2.

The coil device 1 according to the first embodiment includes the core hold member 4 that elastically presses the core 20 toward the attachment surface 3-1. By the core hold member 4 elastically pressing the core 20 toward the attachment surface 3-1, the coil device 1 can be fixed to the housing 3.

The coil device 1 according to the first embodiment includes the case 5 having the wall surface portion 5-2 surrounding the coil body 2 provided on the attachment surface 3-1. The coil body 2 is fixed to the attachment surface 3-1 together with the case 5. Even with such a configuration, the coil body 2 can be fixed to the attachment surface 3-1.

The coil device 1 according to the first embodiment includes the coil fixing portion 5-3 with a shape along the outer shape of the winding portion 20-2a around which the conductive wire 22 is wound in the core portion 20-2. The coil 21 is formed by winding the conductive wire 22 around the winding portion 20-2a with the coil fixing portion 5-3 interposed therebetween. Since the deviation of the core portion 20-2 is suppressed by the coil fixing portion 5-3, the conductive wire 22 can be accurately wound around the winding portion 20-2a.

Note that, in the coil device 1E including the coil fixing portion 5A-3 provided in the case 5C, the effects similar to those described above can be obtained.

The coil device 1 according to the first embodiment includes the positioning wall portion 5-4 that is provided in the coil fixing portion 5-3 and restricts the movement of the core portion 20-1 and the core portion 20-2 in the direction perpendicular to the stacking direction of the core portion 20-1 and the core portion 20-2 stacked on the attachment surface 3-1. Since the positioning wall portion 5-4 restricts the movement of the core portion 20-2, the conductive wire 22 can be accurately wound around the core portion 20-2.

The coil device 1C according to the first embodiment includes the plate-like portion 5-6 that is provided in the case 5A and that has a thickness depending on the distance between the combined surfaces where the core portion 20-1 and the core portion 20-2 are combined with each other. The core portion 20-1 and the core portion 20-2 are combined on the attachment surface 3-1 with the plate-like portion 5-6 interposed between the combined surfaces where the core portion 20-1 and the core portion 20-2 are combined with each other. The plate-like portion 5-6 can change the coil characteristics such as an inductance value or a DC superposition characteristic with the distance between the core portion 20-1 and the core portion 20-2. As a result, the plate-like portion 5-6 can be used instead of the gap sheet 7, and the number of components can be reduced.

Note that the effects similar to those described above can be obtained in the coil device 1D in which the core hold member 4 presses the core 20D with the plate-like portion 5-7 interposed between the core portion 20-1 and the core portion 20-2 toward the attachment surface 3-1.

In the coil device 1 according to the first embodiment, the coil 21 includes the terminal 23 provided at the end portion of the conductive wire 22. The case 5 includes the hole portion 5-5 through which the terminal 23 passes. By passing the terminal 23 through the hole portion 5-5, the position of the terminal 23 can be accurately determined.

The coil device 1 according to the first embodiment includes the positioning recess portion 3-3 provided in the housing 3 and the positioning projection portion 5-1 provided in the case 5 and fitted into the positioning recess portion 3-3 at the attachment position of the case 5 to the housing 3. The case 5 can be accurately positioned on the attachment surface 3-1 by the positioning recess portion 3-3 and the positioning projection portion 5-1.

In the coil device 1 according to the first embodiment, the attachment surface 3-1 includes the recess portion 3-2 and the projection portion 3-4 with a shape along the outer shape of the core portion 20-2 including the coil 21. The core portion 20-2 is provided on the attachment surface 3-1 with the outer shape of the core portion fitted to the recess portion 3-2 and the projection portion 3-4. The coil body 2 can be fixed via the bottom surface of the recess portion 3-2 and the upper surface of the projection portion 3-4.

The coil device 1E according to the first embodiment includes the coil fixing portion 5A-3 that is provided in the case 5C and that has a shape along the outer shape of the winding portion 20-2a around which the conductive wire 22 is wound in the core portion 20-2. The coil 21E is formed by winding the conductive wire 22 around the winding portion 20-2a with the coil fixing portion 5A-3 interposed therebetween. Since the deviation of the core portion 20-2 is suppressed by the coil fixing portion 5A-3, the conductive wire 22 can be accurately wound around the winding portion 20-2a.

In the coil device 1F according to the first embodiment, the coil body 2J includes the coil 21 and the coil 21F each of which has the conductive wire 22 wound around a corresponding one of two portions in the longitudinal direction of the core portion 20B-2. The type of the conductive wire 22 and the number of turns in the coil 21 are the same as those in the coil 21F. As a result, the coil device 1F can be used as coil devices for various applications.

In the coil device 1F according to the first embodiment, the coil body 2J includes the coil 21 and the coil 21F each of which has the conductive wire 22 wound around a corresponding one of two portions in the longitudinal direction of the core portion 20B-2. The coil 21 and the coil 21F are different from each other in at least one of the type of the conductive wire 22 and the number of turns. As a result, the coil device 1F can be used as coil devices for various applications.

In the coil device 1 according to the first embodiment, the conductive wire 22D is a round wire. Since the round wire is more inexpensive than the flat wire, the cost of the coil can be reduced. As a result, cost reduction of the coil device 1 can be expected.

In the coil device 1 according to the first embodiment, the conductive wires 22 and 22A to 22C are flat wires. For example, by forming the coil 21 by bending and winding the long side of the rectangular cross-sectional shape of the flat wire, the area where the conductive wire 22 of the coil 21 and the attachment surface 3-1 face each other is increased, and thus the heat generated in the coil 21 can be efficiently transferred to the housing 3.

In the coil device 1 according to the first embodiment, the conductive wire 22, which is a flat wire, has the inner surface 22-1 facing the core 20 and the outer surface 22-2 opposite to the inner surface 22-1. The coil 21 is wound in such a manner that the outer surface 22-2 of the flat wire is parallel to the attachment surface 3-1.

By winding the flat wire in such a manner that the outer surface 22-2 is parallel to the attachment surface 3-1, the area where the conductive wire 22 of the coil 21 and the attachment surface 3-1 face each other is further increased, and thus the heat generated in the coil 21 can be efficiently transferred to the housing 3.

Hereinafter, various aspects of the present disclosure will be collectively described as supplements.

### (First Supplement)

A coil device comprising:
a coil body including a core and at least one coil formed by winding a conductive wire around the core, the core being formed by combining a plurality of core portions; and
a housing including an attachment surface to which the coil body is fixed,
wherein
the plurality of the core portions includes a first core portion whose longitudinal direction is along a winding axis of the conductive wire and a second core portion other than the first core portion, and
in the core, the first core portion is provided on the attachment surface of the housing, the second core portion is stacked on the first core portion, and combined surfaces where the core portions are combined with each other are parallel to the winding axis.

### (Second Supplement)

The coil device according to first supplement, further comprising a first heat-dissipation member provided between the coil and the attachment surface,
wherein the coil is provided on the attachment surface with the first heat-dissipation member interposed between the coil and the attachment surface.

### (Third Supplement)

The coil device according to first or second supplement, further comprising a second heat-dissipation member provided between a portion of the first core portion other than the coil and the attachment surface,
wherein the portion of the first core portion other than the coil is provided on the attachment surface with the second heat-dissipation member interposed between the portion of the first core portion other than the coil and the attachment surface.

### (Fourth Supplement)

The coil device according to any one of first to third supplements, further comprising a third heat-dissipation member provided between the combined surfaces where the core portions are combined with each other,
wherein the plurality of the core portions is combined on the attachment surface with the third heat-dissipation member interposed between the combined surfaces where the core portions are combined with each other.

### (Fifth Supplement)

The coil device according to any one of first to third supplements, further comprising a sheet member with a thickness depending on a distance between the combined surfaces where the core portions are combined with each other,
wherein the plurality of the core portions is combined on the attachment surface with the sheet member interposed between the combined surfaces where the core portions are combined with each other.

### (Sixth Supplement)

The coil device according to any one of first to fifth supplements, further comprising a core hold member to elastically press the core toward the attachment surface.

### (Seventh Supplement)

The coil device according to any one of first to sixth supplements, further comprising a case member including a wall surface portion that surrounds the coil body provided on the attachment surface,
wherein the coil body is fixed to the attachment surface together with the case member.

### (Eighth Supplement)

The coil device according to any one of first to seventh supplements, further comprising a coil fixing portion with a shape along an outer shape of a winding portion around which the conductive wire is wound in the first core portion,
wherein the coil is formed by winding the conductive wire around the winding portion with the coil fixing portion interposed between the conductive wire and the winding portion.

### (Ninth Supplement)

The coil device according to eighth supplement, further comprising a positioning wall portion to restrict movement of one of the core portions in a direction perpendicular to a stacking direction of the plurality of the core portions stacked on the attachment surface, the positioning wall portion being provided in the coil fixing portion.

### (Tenth Supplement)

The coil device according to any one of seventh to ninth supplements, further comprising a plate-like portion provided in the case member and having a thickness depending on a distance between the combined surfaces where the core portions are combined with each other,
wherein the plurality of the core portions is combined on the attachment surface with the plate-like portion interposed between the combined surfaces where the core portions are combined with each other.

### (Eleventh Supplement)

The coil device according to any one of seventh to tenth supplements, wherein
the coil includes a terminal provided at an end portion of the conductive wire, and
the case member includes a hole portion through which the terminal passes.

### (Twelfth Supplement)

The coil device according to any one of seventh to eleventh supplements, further comprising:
a positioning recess portion provided in one of the housing and the case member; and
a positioning projection portion provided in another of the housing and the case member and fitted into the positioning recess portion at an attachment position of the case member to the housing.

### (Thirteenth Supplement)

The coil device according to seventh supplement, further comprising a coil fixing portion provided in the case member and having a shape along an outer shape of a winding portion around which the conductive wire is wound in the first core portion,
wherein the coil is formed by winding the conductive wire around the winding portion with the coil fixing portion interposed between the conductive wire and the winding portion.

### (Fourteenth Supplement)

The coil device according to any one of first to thirteenth supplements, wherein
the attachment surface includes a recess portion and a projection portion with a shape along an outer shape of the first core portion including the coil, and
the first core portion is provided on the attachment surface with the outer shape of the first core portion fitted to the recess portion and the projection portion.

### (Fifteenth Supplement)

The coil device according to any one of first to fourteenth supplements, wherein
the coil body includes a plurality of coils which is included in the at least one coil, and each of which has the conductive wire wound around a corresponding one of a plurality of portions in the longitudinal direction of the first core portion, and
the plurality of the coils has a same type of the conductive wire and a same number of turns.

### (Sixteenth Supplement)

The coil device according to any one of first to fourteenth supplements, wherein
the coil body includes a plurality of coils which is included in the at least one coil, and each of which has the conductive wire wound around a corresponding one of a plurality of portions in the longitudinal direction of the first core portion, and
the plurality of the coils is different from each other in at least one of a type of the conductive wire and the number of turns.

### (Seventeenth Supplement)

The coil device according to any one of first to sixteenth supplements, wherein the conductive wire includes a round wire.

### (Eighteenth Supplement)

The coil device according to any one of first to sixteenth supplements, wherein the conductive wire includes a flat wire.

### (Nineteenth Supplement)

The coil device according to eighteenth supplement, wherein
the flat wire has an inner surface that faces the core and an outer surface opposite to the inner surface, and
the coil is wound in such a manner that the outer surface of the flat wire is parallel to the attachment surface.

Note that it is possible to modify or omit any component of the embodiment.

### REFERENCE SIGNS LIST

1, 1A to 1F: coil device, 2, 2A to 2J: coil body, 3, 3A: housing, 3-1: attachment surface, 3-2: recess portion, 3-3: positioning recess portion, 3-2: projection portion, 4, 4A: core hold member, 5, 5A to 5D: case, 5-1: positioning projection portion, 5-2: wall surface portion, 5-3, 5-3a, 5-3b, 5B-3: coil fixing portion, 5a-3: hole portion, 5-4, 5a-4: positioning wall portion, 5-5: hole portion, 5-6, 5-7: plate-like portion, 6: fixing screw, 7: gap sheet, 8 to 11: heat dissipation member, 20, 20A to 20F: core, 20-1, 20A-1, 20-3: core portion, 20-2a, 20-2b: winding portion, 21, 21A to 21F: coil, 22, 22A to 22E: conductive wire, 22-1, 22A-1, 22B-1: inner surface, 22-2, 22A-2, 22B-2: outer surface, 23: terminal, 100: winding axis

1. A coil device comprising:
a coil body including a core and at least one coil formed by winding a conductive wire around the core, the core being formed by combining a plurality of core portions; and
a housing including an attachment surface to which the coil body is fixed,
wherein
the plurality of the core portions includes a first core portion whose longitudinal direction is along a winding axis of the conductive wire and a second core portion other than the first core portion, and
in the core, the first core portion is provided on the attachment surface of the housing, the second core portion is stacked on the first core portion, and combined surfaces where the core portions are combined with each other are parallel to the winding axis.

2. The coil device according to claim 1, further comprising a first heat-dissipation member provided between the coil and the attachment surface,
wherein the coil is provided on the attachment surface with the first heat-dissipation member interposed between the coil and the attachment surface.

3. The coil device according to claim 2, further comprising a second heat-dissipation member provided between a portion of the first core portion other than the coil and the attachment surface,
wherein the portion of the first core portion other than the coil is provided on the attachment surface with the second heat-dissipation member interposed between the portion of the first core portion other than the coil and the attachment surface.

4. The coil device according to claim 3, further comprising a third heat-dissipation member provided between the combined surfaces where the core portions are combined with each other,
wherein the plurality of the core portions is combined on the attachment surface with the third heat-dissipation member interposed between the combined surfaces where the core portions are combined with each other.

5. The coil device according to claim 3, further comprising a sheet member with a thickness depending on a distance between the combined surfaces where the core portions are combined with each other,
wherein the plurality of the core portions is combined on the attachment surface with the sheet member interposed between the combined surfaces where the core portions are combined with each other.

6. The coil device according to claim 1, further comprising a core hold member to elastically press the core toward the attachment surface.

7. The coil device according to claim 1, further comprising a case member including a wall surface portion that surrounds the coil body provided on the attachment surface,
wherein the coil body is fixed to the attachment surface together with the case member.

8. The coil device according to claim 1, further comprising a coil fixing portion with a shape along an outer shape of a winding portion around which the conductive wire is wound in the first core portion,
wherein the coil is formed by winding the conductive wire around the winding portion with the coil fixing portion interposed between the conductive wire and the winding portion.

9. The coil device according to claim 8, further comprising a positioning wall portion to restrict movement of one of the core portions in a direction perpendicular to a stacking direction of the plurality of the core portions stacked on the attachment surface, the positioning wall portion being provided in the coil fixing portion.

10. The coil device according to claim 7, further comprising a plate-like portion provided in the case member and having a thickness depending on a distance between the combined surfaces where the core portions are combined with each other,
wherein the plurality of the core portions is combined on the attachment surface with the plate-like portion interposed between the combined surfaces where the core portions are combined with each other.

11. The coil device according to claim 7, wherein
the coil includes a terminal provided at an end portion of the conductive wire, and
the case member includes a hole portion through which the terminal passes.

12. The coil device according to claim 7, further comprising:
a positioning recess portion provided in one of the housing and the case member; and
a positioning projection portion provided in another of the housing and the case member and fitted into the positioning recess portion at an attachment position of the case member to the housing.

13. The coil device according to claim 7, further comprising a coil fixing portion provided in the case member and having a shape along an outer shape of a winding portion around which the conductive wire is wound in the first core portion,
wherein the coil is formed by winding the conductive wire around the winding portion with the coil fixing portion interposed between the conductive wire and the winding portion.

14. The coil device according to claim 1, wherein
the attachment surface includes a recess portion and a projection portion with a shape along an outer shape of the first core portion including the coil, and
the first core portion is provided on the attachment surface with the outer shape of the first core portion fitted to the recess portion and the projection portion.

15. The coil device according to claim 1, wherein
the coil body includes a plurality of coils which is included in the at least one coil, and each of which has the conductive wire wound around a corresponding one of a plurality of portions in the longitudinal direction of the first core portion, and
the plurality of the coils has a same type of the conductive wire and a same number of turns.

16. The coil device according to claim 1, wherein
the coil body includes a plurality of coils which is included in the at least one coil, and each of which has the conductive wire wound around a corresponding one of a plurality of portions in the longitudinal direction of the first core portion, and
the plurality of the coils is different from each other in at least one of a type of the conductive wire and the number of turns.

17. The coil device according to claim 1, wherein the conductive wire includes a round wire.

18. The coil device according to claim 1, wherein the conductive wire includes a flat wire.

19. The coil device according to claim 18, wherein
the flat wire has an inner surface that faces the core and an outer surface opposite to the inner surface, and
the coil is wound in such a manner that the outer surface of the flat wire is parallel to the attachment surface.
